(19) United States
(12) Patent Application Publication
(10) Pub. No.: US 2019/0332912 A1
(43) Pub. Date: Oct. 31, 2019

(54) WEB BASED APPLICATIONS LINKED TO NEAR FIELD COMMUNICATION TAGS

(71) Applicant: Matthew WALKER, Saint Petersburg, FL (US)

(72) Inventor: Matthew WALKER, Saint Petersburg, FL (US)

(21) Appl. No.: 16/397,933

(22) Filed: Apr. 29, 2019

Related U.S. Application Data
(60) Provisional application No. 62/664,589, filed on Apr. 30, 2018.

(51) Int. Cl. G06K 19/077; G06K 7/10; G06F 16/955

(52) U.S. Cl. CPC G06K 19/0776; G06F 16/955; G06K 7/10386

(57) ABSTRACT

The invention pertains to a system for creating simple and efficient storing content such as video and audio files using near field communication (NFC) tags to link the applications to web stored content such as video and audio files.

### CROSS-REFERENCE TO RELATED APPLICATION

This application claims priority from U.S. Provisional Patent Application No. 62/664,589, filed Apr. 30, 2018, titled WEB BASED APPLICATIONS LINKED TO NEAR FIELD COMMUNICATION TAGS which is hereby incorporated by reference herein for all purposes.

### BACKGROUND OF THE INVENTION

### 1) Field of the Invention

The invention pertains to the field of advertising and more specifically to a system for creating simple and efficient web-based applications using Near Field Communication (NFC) tags.

### 2) Description of Related Art

There are numerous advertisements systems using barcodes and NFC tags. Among these are the Cue-Cat system and the Google® Nexus S device. Disadvantageously, the Cue-Cat system requires a user to connect the Cue-Cat device to a computer and scan bar codes from advertisements to go to a web site for more information or special offers. This requires the user to read and scan the information while at the keyboard, limiting the options for advertisers and inconveniencing the user. The Google® Nexus S has the same capabilities as the Cue-Cat to launch a web site in a phone's web browser by scanning an NFC tag containing the URL. An NFC tag utilizes a wireless radio communications standard to communicate information to a smart device that is capable of activating the NFC tag and reading the information stored on the tag. In the wireless world, NFC's closest relative is actually radio frequency identification (RFID). Retailers and parcel shipping companies in particular use RFID as a way to keep tabs on inventory supplies and shipments.

Therefore, there exists a need for a system for creating simple and efficient web-based applications using NFC tags.

### BRIEF SUMMARY OF THE INVENTION

The invention in one form is directed to a near field communication (NFC) tag system for recording content. The NFC tag system includes an NFC tag, an NFC tag maker application, an NFC enabled mobile device, an NFC mobile device application, an NFC writer application and a web backend in communication with the NFC Writer application.

The invention in another form is directed to another near field communication (NFC) tag system. The NFC tag system including a data storage, a video content, an audio content, a web server and an NFC tag code. The web server includes a server computer application associated with the data storage. The NFC tag code is configured for storing the video content and the audio content on the web server. The server computer application is configured for associating the NFC tag code with the video and the audio content. The video content and the audio content are accessible by the server computer application using the NFC tag code.

In yet another form, the invention provides a method for displaying information about an object on a mobile device. The method includes a first step of providing a tag where the tag includes a unique identifier. The next step is to affix the tag to the object. The next step is to associate the unique identifier to the information about the object where the information is stored on a web server. The next steps are to read the unique identifier with a mobile device and then retrieve the information about the object from the web server. The last step is to display the information about the object on the mobile device.

In another embodiment there is provided another method for using the system. The method includes the first step of creating the NFC tag association on the backend system. The next step downloads an application onto a compatible device to login to the user account. Then the system synchronizes content selected by the user between the device and the account. The next step is to scan an NFC tag associated with a content such as web URL, pictures, videos, audio, advertisement files products, fliers, or any other objects stored on host server or stored images. The system then downloads instructions operable on the device to launch an application associated with the NFC tag. The last step includes an interaction with the application on the device. The system can also incorporate a user account that is stored on the NFC enabled mobile device. The user account includes a comprehensive profile which provides a richer and more personalized experience to the user. Interacting with the application on the device also includes displaying content such as web URL, pictures, videos, audio, advertisement files products, fliers, or any other objects stored on host server or stored images to the user.

An advantage of the present invention is that information about an object is not limited by the size and/or type of object.

Another advantage of the present invention is a simple and easy system to associate information on a backend website with the NFC tag on the object.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a diagram of the NFC tag;

FIG. 2 is a is a diagram of the system;

FIG. 3 is flow chart of the phone application; and

FIG. 4 is a diagram illustrating how the backend communicates with the NFC enabled mobile device.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

When used within the specification the terms content, web URL, pictures, videos, audio, advertisement files products, fliers, or any other objects stored on host server or stored images all refer to content to be created of displayed by the instant invention and are used interchangeably.

When used within the specification the terms users, clients, customers companies and corporations all refer to users of the technology and are used interchangeably.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

The near field communications (NFC) tags may include a unique code which when coupled with an application is capable of communicating with the web backend of the instant invention to retrieve content associated with the unique code. The application can be launched in a web browser on a mobile device such as a smart phone or tablet. Alternatively, the unique code could be encoded into a QR code however it is a less permanent method of capturing data because QR codes can be easily damaged.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

All dimensions specified in this disclosure are by way of example only and are not intended to be limiting. Further, the figures are not necessarily to scale. As will be understood by those with skill in the art with reference to this disclosure, the actual dimensions of any device or part of a device disclosed in this disclosure will be determined by its intended use.

In the following description, specific details are given to provide a thorough understanding of the embodiments. However, it will be understood by one of ordinary skill in the art that the embodiments can be practiced without these specific details. Well-known circuits, structures and techniques may not be shown in detail in order not to obscure the embodiments. For example, circuits can be shown in block diagrams in order not to obscure the embodiments in unnecessary detail.

Also, it is noted that the embodiments can be described as a process that is depicted as a flowchart, a flow diagram, a structure diagram, or a block diagram. Although a flowchart can describe the operations as a sequential process, many of the operations can be performed in parallel or concurrently. In addition, the order of the operations can be rearranged. A process is terminated when its operations are completed. A process can correspond to a method, a function, a procedure, a subroutine, a subprogram, etc. When a process corresponds to a function, its termination corresponds to a return of the function to the calling function or the main function.

Moreover, a storage can represent one or more devices for storing data, including read-only memory (ROM), random access memory (RAM), magnetic disk storage mediums, optical storage mediums, flash memory devices and/or other machine-readable mediums for storing information.

Furthermore, embodiments can be implemented by hardware, software, firmware, middleware, microcode, or a combination thereof. When implemented in software, firmware, middleware or microcode, the program code or code segments to perform the necessary tasks can be stored in a machine-readable medium such as a storage medium or other storage(s). A processor can perform the necessary tasks. A code segment can represent a procedure, a function, a subprogram, a program, a routine, a subroutine, a module, a software package, a class, or a combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted through devices configured for memory sharing, message passing, token passing, network transmission, etc.

In the following description, certain terminology is used to describe certain features of one or more embodiments of the invention.

The term “machine readable medium” includes but is not limited to portable or fixed storage devices, optical storage devices, wireless channels and various other mediums capable of storing, containing or carrying instruction(s) and/or data.

The instant invention is based on an NFC enabled mobile device application which associates the NFC tag encoded random string of alphanumeric text code with the content which the user wants to display. The content is displayed when the NFC tag is interrogated by the NFC enabled mobile device using an NFC enabled mobile device application, a web host server, and a computer application for distributing content. The content can include anything such as applications, pictures, videos, audio and advertisement files created by the NFC tag writer application or NFC enabled mobile device application. The NFC tag writer application or NFC enabled mobile device application includes templates and an application program interface for creating content such as pictures, videos, audio and advertisement files. The web backend, which communicates with the NFC enabled mobile device, has a web host server and a computer application for displaying content such as pictures, videos, audio and advertisement files. The content is contained in the web back end and is displayed on the NFC enabled mobile device when the NFC enabled mobile device application transmits the NFC tag encoded random string of alphanumeric text code to the web backend. The web backend then transmits the associated content files to the NFC enabled mobile device application for viewing.

The present invention solves many of the problems currently encountered with digital marketing associated with barcodes, QR codes, RFID systems and URL marking. The invention solves those issues and provides a platform which is user friendly and capable of being used to display a range of content, e.g., web URL, pictures, videos, audio, advertisement files products, fliers, or any other objects stored on host server or stored images. The invention provides an experience that takes place in the real world and in real time. It enables the information uptake from the physical world by bringing the tools and innovations of computing power of the web on to the user's palm. NFC tags are relatively cheap to produce and can therefore be implemented into products, family mementos, memorabilia, educational materials, architectural features and signage in a cost-effective manner. Manufacturing is simplified because the manufacturer does not have to encode a unique indicator but can encoded random string of alphanumeric text into the NFC tag. The user then can associate the NFC tag with the specific information links that they want to view when the NFC tag is interrogated by an NFC enabled mobile device. Additionally, commercial printing methods can print NFC tags for individual or lower quantity runs. This enables objects encountered on a daily basis to carry an NFC tag, enabling a user to tap on these objects and gain access to content such as web URL, pictures, videos, audio, advertisement files products, fliers, or any other objects stored on host server or stored images associated with the object, instantly.

A cost-effective NFC tag for use with the invention can be manufactured as shown in U.S. Pat. No. 9,210,806, titled Bondable Conductive Ink issued on Dec. 8, 2015 the disclosure of which is hereby incorporated by reference herein for all purposes.

The NFC tag used in the instant invention is the component that stores the code to be read. The basic concept of ‘passive’ NFC technology relates to an NFC tag that does not possess electronic ‘awakening’ until a reading device with an NFC reader is in close proximity. The reading device creates an electromagnetic field by way of induction which is used to create a current in the antenna of the passive NFC device. This electromagnetic field actually powers the NFC tag so that it's code can be read by the reading device. It should be recognized that the NFC tag may be of any size or dimension suitable for use. In general, a larger NFC tag requires a more intense electromagnetic field/closer proximity from the reading device to work. In contrast, a smaller NFC tag requires a precise alignment of the reading device with the NFC tag, and thus may limit usability by casual users who simply want to ‘tap’ their reading device to an NFC. A balance between the required electromagnetic field, proximity and precision may be obtained with an NFC tag of 38 mm. For use with the instant invention the NTAG210 NFC tag has been determined to an ideal NFC tag technology since it widely accepted by most reading device with NFC readers and has a memory footprint which is ideal for storing NFC tag codes. The reason small codes (30 to 40 characters) are used relates to power requirements, i.e., lower power requirement equates to less NFC field proximity.

For example, if the user wanted to associate a video of a loved one with a picture then the tag would be attached to the picture and associated with the video which would be stored in the web backend. When the tag is interrogated the NFC reader, the mobile application would communicate with the web backend and display the video for the user on their mobile device.

If the user wanted to associate an audio file with a memorabilia piece, then the tag would be attached to the memorabilia piece and associated with the audio file which would be stored in the web backend. When the tag is interrogated the NFC reader, the mobile application would communicate with the web backend and play the audio file for the user on their mobile device.

A commercial example would be if the user would like to see if a memory card that they are about to purchase is compatible with a specific brand of camera and the memory card packaging had an NFC tag of the invention. The user can tap on the memory card packaging containing an NFC tag and the NFC enabled mobile device will display the information such as web retrieval, i.e., the URL or display, e.g., an image. Additionally, if the user would like to see a trailer of a movie or video game displayed on a shelf and the packaging had an NFC tag of the invention, the user only needs to tap on the package. Trailers, reviews, and user feedback are then made available with a single tap. Another commercial example provides that the user can place an order by simply tapping over a pizza flyer having an NFC tag of the invention, the NFC tag can send the information about the item desired and couple it with the user's information stored on the NFC enabled mobile device to the restaurant. The invention allows users to provide a simple method for customers to communicate and receive media rich brochures, event flyers that automatically synchronize with your calendar, and coupons that alert you when they are about to expire.

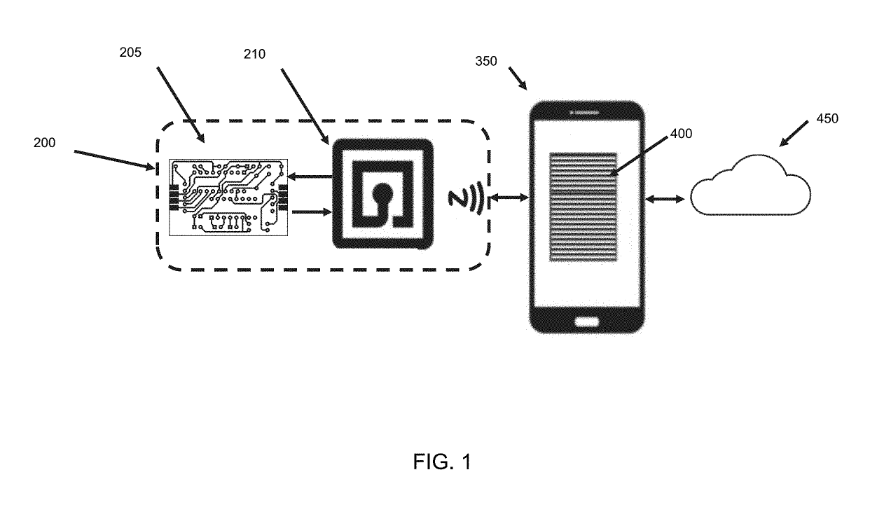

Referring now to FIG. 1 the NFC tag 200 includes a circuit 205 where the code 201 is stored and an antenna 210 to power the circuit 205. Power to the antenna 210 may be received from the magnetic field produced by the NFC enabled device 350. When the antenna 210 is powered, the NFC tag 200 transmits the code 201 to the NFC enabled device 350 for use by NFC enabled device application 400 and cloud 450.

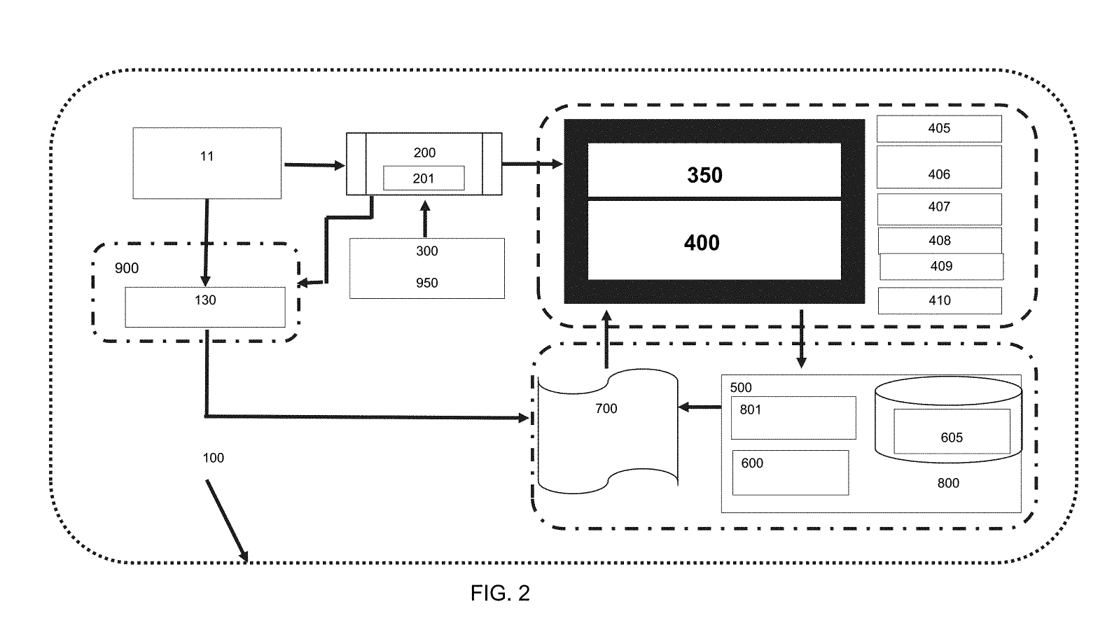

The system will now be disclosed in detail. Referring now to FIG. 2, there is shown an NFC tag system 100 for creating simple and efficient web-based applications using near field communications NFC tags 200. The NFC tags 200 are used to link the applications on an NFC enabled mobile device 350 to content such as pictures, videos, audio, advertisement files products, fliers, or any other objects stored on a host server 500. The NFC tag system 100 generally includes an NFC tag 200, an NFC tag maker 300, an NFC enabled mobile device 350 having an NFC reader 405, an internet connectivity 406, a display 407, a camera 408, a microphone 409, a speaker 410 and an NFC enabled mobile device application 400. The NFC enabled mobile device application 400 is in communication with web backend 800 which includes a host server 500 which may be an internet-based web server with data storage 605 and computer application 600. The computer application 600 manages the content 700 such as pictures, videos, audio, advertisement files products, fliers, or any other objects stored on data storage 605. The computer application 600 may include different modules including NFC tag code 201, an ownership module 601, an NFC tag code 201 user validation module 602, an NFC tag code 201 authentication module 603 and an NFC tag code 201 lookup module 604.

The NFC tags could be used for any type of application. Typical applications may include a digital link for: a Christmas ornament, a picture frame, a photo album, a postcard, an envelope, a stamp, a slab for coins, a cremation box, a keepsakes from an event, e.g., cups and koozies, a placemat at a restaurant, a display placard, e.g., small placard at a museum with written words or video assigned to an artist's placard at an event, a home plaque, e.g., picture or plaque of a home, a holiday or greeting card, coasters, file folders, school folders, school notepads, notepads, e.g., moleskins, mousepads, iron-on patches, scrapbooks, cookbooks, a whiteboard, a scavenger hunt token, e.g., geolocation feature, a Tervis or a cup, keychain badges or charms and/or stickers.

The NFC tag maker 300 on computer 950 may be used by a user 11, e.g., clients, customers, large companies and corporations to create the NFC tag 200 code 201 using the tag maker application 300 to write the NFC tag 200 code 201. The code 201 is an encoded random string of alphanumeric text.

The NFC tag system 100 may be used to capture the content 700 such as pictures, videos, audio, advertisement files products, fliers, or any other objects using the NFC enabled mobile device 350 having a camera 408 and/or a microphone 409. The NFC enabled mobile application 400 interrogates the NFC tag 200 code 201 with NFC reader 405. The NFC reader 405 then transmits the NFC tag 200 code 201 to a web backend 800 using internet connectivity 406. The process can also be implemented in reverse where the NFC tag 200 code 201 is first read by the with NFC reader 405 then the NFC enabled mobile application 400 acquires the content such as pictures, videos, audio, advertisement files products, fliers, or any other objects 700 using the NFC enabled mobile device 350 and captures the picture, video or audio file using camera 408 and microphone 409.

The web backend 800 includes a host server 500, data storage 605, an internet connectivity 801 and a computer application 600. The computer application 600 receives the content 700 such as pictures, videos, audio, advertisement files products, fliers, or any other objects and stores them in data storage 605 using NFC tag 200 code 201 as the key to the data.

When the users 11 want to retrieve the content 700, they use the NFC enabled mobile application 400 on an NFC enabled mobile device 350. The NFC enabled mobile device 350 then interrogates the NFC tag 200 code 201 with NFC reader 405. The NFC enabled mobile application 400 then contacts the web backend 800 using internet connectivity 406 and communicates with internet connectivity 801 on web backend 800 host server 500. The host server utilizes the computer application 600 to retrieve the content 700 from the data storage 605 associated with the code 201. The computer application 600 then transmits the content 700 using the internet connectivity 801 which communicates with internet connectivity device 406 on NFC enabled mobile device 350. The NFC mobile device application 400 then displays the content 700 using display 407, microphone 409 and speaker 410.

Alternatively, the users 11 can use the NFC writer application 130 on server 900 to store content 700 associated with NFC tag 200 code 201. The computer application 600 on host server 500 receives the content 700 and the NFC tag 200 code 201 from the internet connectivity 801 and stores them in data storage 605 using the code 201 as the key to the data.

As can be seen, the NFC tag system 100 allows clients 11 to use an NFC tag maker application 300 on computer 950 to write the code 201 to the NFC tag 200 with an NFC writer application 130 or the NFC enabled mobile device application 400 that associates the NFC tag 200 to the code 201. The code 201 is then associated with the content 700 which the user wants to display when the NFC tag 200 is interrogated by the NFC enabled mobile device 350. The application maker includes templates and an application program interface for creating content 700, web backend 800 which communicates with the NFC enabled mobile device 350 and the NFC writer application uses a host server 500 and computer application 600 for storing and retrieving content 700 associated with the code 201.

The NFC enabled mobile device application 400 may have several integrated technologies. An NFC reader 405 that emits the NFC field needed to awaken a passive NFC tag 200. An OS that exposes the behavior of the NFC reader 405 to third party apps on the device. Internet connectivity 406 may be over any suitable system such as a wireless network, e.g. 4G or local network, e.g. WIFI. A display 407 used to display media and content to the customer. A speaker 410 used to play audio content to the customer

In operation, the user 11 articulates the device in close enough proximity, dependent upon overall size of the NFC tag 200. For instance, an NFC tag 200 of 38 mm in size requires the device to be articulated less than 24 mm away and may operate best at a distance of 10 to 13 mm. Articulating the device at a proper distance awakens the NFC tag and the NFC enabled mobile device application 400. The NFC enabled mobile device application 400 will then coordinate the other components of the NFC enabled mobile device application 400 on and the NFC tag system 100.

User interaction is performed by screens in the NFC enabled mobile device application 400 informing the user about what is happening or asking the user for input, e.g., authentication. Additional features of the NFC enabled mobile device application 400 apart from the core features already described may include a history of previously viewed NFC tag 200, the ability to retrieve the NFC tag 200 contents without the presence of a physical NFC tag 200 being present, allowing the NFC enabled mobile device application 400 to assign an ‘Alias’ to a NFC tag 200 which can then be used to retrieve the NFC tag 200 contents, and/or the NFC enabled mobile device application 400 can be modified on a periodical basis to either add features or address bug-fixes.

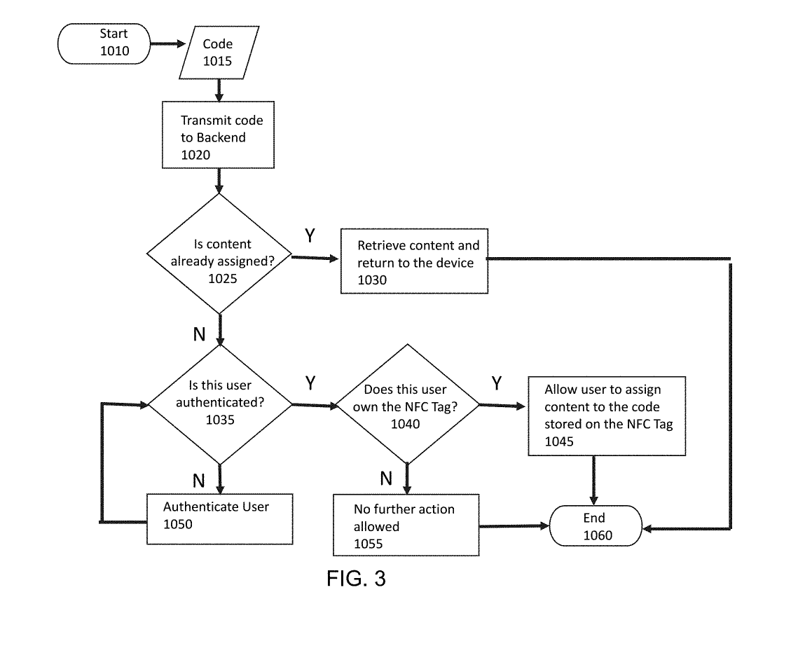

Referring now to FIG. 3 there is a flowchart showing how the NFC enabled mobile device application 400 coordinates the components of the invention. The NFC enabled mobile device application 400 coordinates components on the NFC enabled mobile device application 400 to both read and display an NFC tag encoded random string of alphanumeric text code 201 as well as assign content to an un-assigned NFC tag 200. Once the NFC enabled mobile device application 400 is awakened by the customer articulating the NFC enabled mobile device 350, the NFC enabled mobile device application 400 then communicates with the web backend 800 accessing the code 201 from the NFC library 810 of the web backend 800 on the host OS. Directing attention to FIG. 3, the algorithm starts at step 1010 with the NFC enabled mobile device application 400 interrogating the NFC tag 200 code 201 in step 1015 and transmitting the NFC tag 200 code 201 to the web backend 800 in step 1020. The computer application 600 on host server 500 which is part of web backend 800 then checks the data storage 605 using NFC tag code 201 lookup module 604 to determine if the NFC tag 200 code 201 is already assigned in step 1025. If the NFC tag code 201 is being used then the computer application 600 on host server 500 retrieves content 700 in step 1030 and returns the information to the NFC enabled mobile device application 400 associated with the NFC tag 200 code 201.

If the NFC tag 200 code 201 is not already assigned the computer application 600 on host server 500 checks the authentication of the users 11 using NFC tag code 201 authentication module 603. If they are not an authorized user, the computer application 600 authenticates the users 11 in step 1050 using NFC tag code 201 user validation module 602. If the users 11 are authenticated in step 1035, the computer application 1040 determines if the users 11 owns the NFC tag 200 step 1040 using NFC tag code 201 ownership module 601. If they do not own the NFC tag 200, then the computer application 600 does not allow any further processing and ends the process. If the NFC tag 200 is owned by the users 11, then the computer application 600 allows the users 11 to store content and associate the content to the NFC tag 200 code 201. Once the NFC tag 200 code 201 is associated with content, then the computer program 600 ends the process.

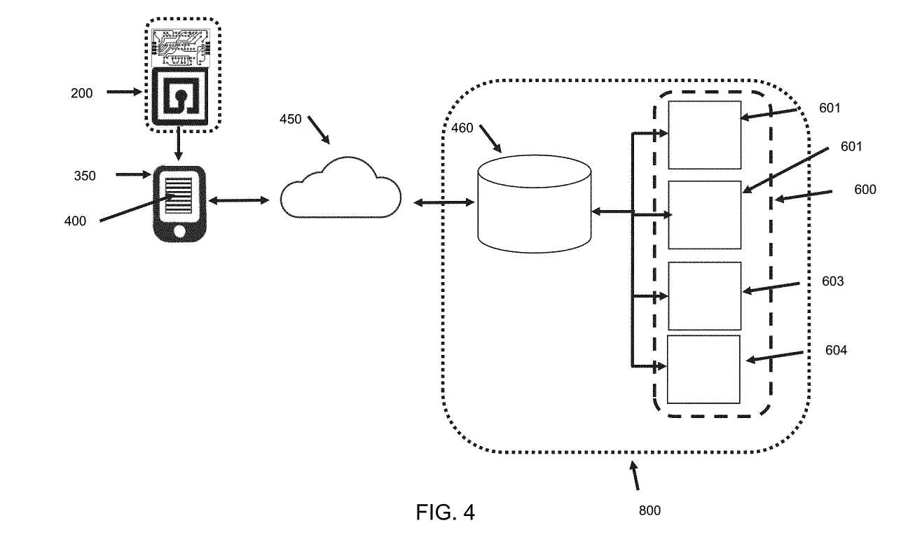

Referring now to FIG. 4, there is shown a diagram of web backend 800 which communicates with the NFC enabled mobile device 350 with a web host server 500 and computer application 600 for storing and retrieving content 700. The web backend 800 is ‘tethered’ to the NFC enabled mobile device application 400 via the internet and facilitates requests by the NFC enabled mobile device application 400 as described in the FIG. 2. A suitable protocol is selected such as HTTP for the communication back and forth between the NFC enabled mobile device application 400 and web backend 800, but this is not a requirement as even a custom protocol could be created/employed to facilitate communication. The web backend 800 also includes a series of utilities that may be leveraged or created to perform certain automation and tasks, e.g., create a new user or assign N number of NFC tag 200 codes to a customer. These may or may not have a user interface. The web backend 800 may be modified on a regular basis to either add features or address bug-fixes.

The NFC enabled mobile device application 400 is capable of associating the NFC tag 200 code 201 with a user 11 and transferring that information using internet connectivity 406 to web backend 800 where internet connectivity 801 transfers the information of the NFC tag 200 code 201 with user 11 to computer application 600 for storage on data storage 605.

In practice a restaurant can strategically place an NFC tag 200 in places where they want costumers to be able to access restaurant information such as in a table place mat. These locations can include, but are not limited to, an NFC tag 200 placed on tables, placed on props on the table, placed on physical menus, brochures, carry out packaging and bags, and placed on store fronts.

Users can tap their NFC enabled mobile device 350 on an NFC tag 200. Then, the NFC enabled mobile device 350 will read the information on the NFC tag 200, launch the web browser, connect to the web backend 800 and retrieve the relevant information using the unique code 201 that is encoded on the NFC tag 200 and then return the information to the NFC enabled mobile device application 400 so it can be displayed using display 407 and speaker 410 to the customer.

Magazine articles can have NFC tag 200 that contain the code 201 for retrieving interactive media that users can access. It can be a video that compliments an article, or a demo of a new product or a concept, sample music, or a slide show. The NFC tag 200 must be strategically placed throughout the magazine to prevent the NFC enabled mobile device application 400 from reading multiple tags at once.

Coupons such as any physical advertisement in a magazine, flier, or poster can carry an NFC tag 200 that will allow the user to save the information from the advertisement.

Video games and movies may have packaging with an NFC tag 200 that launches an NFC enabled mobile device application 400 that communicates the code 201 with the web backend 800 and will provide information to the customer about the video game or movie.

The instant invention when used with a photo album an individual places an NFC tag 200 on the page in the photo album that they want to link with specific web page containing a video relevant to the page they are on. This allows the individual to scan the NFC tag 200 of the invention, and the NFC tag 200 can then send the information to the NFC enabled mobile device and associated application which links it to the applicable web page where the desired information audio, content such as pictures or video are stored, and the information can be displayed on the NFC enabled mobile. This provides the individual a way of incorporating video and audio into the photo album on a specific page. This works well if there is only one NFC tag in the album. However, if there is more than one the NFC tags, the tags on pages under the subject page can interfere with the tag being interrogated. The invention further restricts the reading of a tag to only the tag being interrogated by manufacturing the tag so that the tag has a thin piece of metal on the back side of the tag. The metal acts to obstruct the electromagnetic field created by the reading device to power the NFC tag.

The instant invention can also be used at events to provide a way to record videos and create an association with an NFC tag. The process provides that the NFC tag is incorporated into an item that is either acquired or received at an event. When the NFC tag is read by an NFC enabled mobile device, the NFC enable mobile device will receive the of alphanumeric text code stored on the NFC tag and will transfer it to the mobile application on the NFC enabled mobile device thereby allowing the individual to create a video or audio file on the mobile application and transfer the video or audio and associated alphanumeric text code to a web host server and computer application for storing the video or audio and the associated alphanumeric text code. When the NFC tag is rescanned, the video or audio file associated with the alphanumeric text code is displayed on the mobile application. The web host server and computer application could also associate all the videos or audio files into a string of video or audio files which are associated with all the NFC tags activated at the event so that if any of the NFC tags are activated, the mobile application will display all the associated videos or audio files. The NFC tags can be incorporated into a variety of event memorabilia or party favor such as beaded necklaces, medallions, cups, and/or gift bags and provides the ability for the memorabilia or party favor to possesses a technology allowing it to summarize an event with videos or audios.

Although the system 100 infrastructure can only be limited by the creativity of the user, there are many unique and exciting functionality that can be developed using this system as can be appreciated by those with skill in the art with reference to this disclosure.

The instant invention when used as part of community content can provide a wall that is painted and has 25 NFC tag 200 at various locations placed on it before being painted. Random people are able to approach the wall and assign their own videos to the mural using the NFC tag 200. In return, other random people are able to visit the wall and view videos that were assigned by other people. This provides a new type of media that when applied to anything, allows for digital content to be assigned/played back by anyone.

The general flow of processes using the above components can be summarized an order for twenty NFC tag 200 is made by a user 11. Twenty 38 mm NTAG210 NFC tags 200 can be obtained from a 3rd party supplier. Twenty codes 201 are generated and assigned to a user 11 using an NFC tag maker application 300. After the NFC tags 200 codes 201 are written to the NFC tags 200, a bit is set on the NFC tag 200 with the NFC writer application 130 that prevents the codes from being erased or over-written, e.g., the NFC tag 200 is forced into a read-only state. They are now ‘live’ meaning they have just become twenty unique NFC tags 200. All twenty NFC tags 200 are sent to the user 11. Using the NFC enabled mobile device application 400 or the NFC writer application 130, the user 11 will assign desired content to each of the twenty NFC tags 200 and use them in whatever style of fashion they determine, e.g., on photo albums, memorabilia, beaded necklaces, promotional materials, postcards, on greeting cards, on the back of a photo album, etc. The NFC tags 200 sit in a passive state until someone with the NFC enabled mobile device application 400 articulates their NFC enabled mobile device 350, with an NFC Reader 405, so that is within 10 to 13 mm of the NFC tags 200. The NFC enabled mobile device application 400 is immediately awakened, retrieves the NFC tags 200 code 201 and then displays the content that the user 11. If the user 11 walks away, the content is still present. The proximity was only required to read the code 201 only and the customer can walk away while still viewing the content transmitted from the Web Backend 800. This process can take place until the NFC tags 200 is physically destroyed, the code 201 is erased from the web backend 800 database, the web backend 800 is destroyed or the code 201 is removed from the backend.

When used with at an event there are a number of scenario's where the instant invention can be employed such as a party is thrown and those attending are given a beaded necklace with an NFC tag 200 in the medallion of the necklace. Throughout the event when people interact with the NFC tag 200 by utilizing their NFC enabled mobile device, they are given the ability to record a video of their experience at the party, of themselves, or others, similar to the concept of a disposable camera left on tables at weddings. Twenty-four hours after the event begins, all videos are placed end-to-end and exclusively accessible by using any of the NFC tag 200 that is registered as being at the event. Each of the beaded necklaces that were used at the party by the guests that attended will have access to the video stream.

Another scenario is a party is thrown and those attending are given a cup with an NFC tag 200 on it. After the event, a video summarizing the event is associated with the NFC tag 200 of the cups at the party and the videos of the party are associated with the NFC tag 200 on the cups. Therefore, all people that attended and kept their cups can watch the video that was made of the party.

The instant invention creates a unique medium for creating memorabilia or unique party favor such as a cup, beaded necklace, gift bag, etc. for an event. The memorabilia or unique party favor made with the instant invention possesses a technology that allows each guest to record videos and access them from the web backend by reading the code on the NFC tag 200 and they are capable of viewing them directly on their NFC enabled mobile device. The NFC tag 200 allows the event organizers to summarize an event with videos taken at the event.

The instant invention when used as part of a home appliance can create a home device used for the localized storing of memories and memorable content. For instance, a family visits the Grand Canyon and, collectively, take thirty videos on their phones. Three of those thirty are chosen to go behind three framed pictures from the visit to the Grand Canyon. When each video is assigned to the picture frame, the video is stored on the NFC tag 200 appliance in a non-proprietary format. The instant invention, when utilized in this manner provides for the storage of memories and media in such a way that it is localized and in possession of the person/family/household.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A near field communication ('NFC') tag system for recording content, comprising:
an NFC tag;
an NFC tag maker application;
an NFC enabled mobile device;
an NFC mobile device application;
an NFC writer application; and
a web backend in communication with the NFC Writer application.

2. The NFC tag system of claim 1, wherein the NFC tag maker application encodes an encoded random string of alphanumeric text on the NFC tag as an NFC tag code.

3. The NFC tag system of claim 1, wherein the NFC enabled mobile device includes an NFC reader, a mobile device internet connection, a display, a speaker, a camera, a microphone, and an NFC enabled mobile application in communication with the NFC enabled mobile device.

4. The NFC tag system of claim 3, wherein the camera is configured for recording a video content or a picture content to the NFC enabled mobile application.

5. The NFC tag system of claim 3, wherein the microphone is configured for recording an audio content to the NFC enabled mobile application.

6. The NFC tag system of claim 3, wherein the NFC mobile device application is adapted to the NFC enabled mobile device having an NFC reading configured for reading the NFC tag code and an internet conductivity for transferring the NFC tag code and the video content and the audio content to the web backend.

7. The NFC tag system of claim 1, wherein the web backend includes an internet server connection, a computer server application, a data storage, and a content stored on the data storage, the data storage including a video content and an audio content associated with the NFC tag code.

8. The NFC tag system of claim 7, wherein the computer server application is configured to retrieve the video content and the audio content associated with the NFC tag code stored on the data storage, the computer server application further configured to transfer the video content, the audio content and the NFC tag code to the NFC enabled mobile application using the internet server connection to the mobile device internet connectivity to the NFC mobile device application and displaying the video content and the audio content and the NFC tag code on the display and the speaker.

9. A near field communication ('NFC') tag system, comprising:
a data storage;
a video content;
an audio content;
a web server having a server computer application associated with the data storage; and
an NFC tag code configured for storing the video content and the audio content on the web server, the server computer application configured for associating the NFC tag code with the video and the audio content, the video content and the audio content being accessible by the server computer application using the NFC tag code.

10. The NFC tag system of claim 9, wherein the server computer application receives the NFC tag code from a mobile device using an internet connection, the server computer application configured for verifying that the NFC tag code has been assigned to the video and the audio content.

11. The NFC tag system of claim 10, wherein the server computer application retrieves the video content and the audio content from the data storage and then transfers the video content and the audio content via the internet connection to the mobile device if the NFC tag code has been assigned to the video content and the audio content.

12. The NFC tag system of claim 10, wherein the server computer application retrieves the video content and the audio content from the mobile device via the internet connection and associates the NFC tag code with the video content and the audio content and then stores it in the data storage if the NFC tag code has not been assigned to the video content and the audio content.

13. The NFC tag system of claim 9, wherein the server computer application is configured for assigning the NFC tag code to a user.

14. The NFC tag system of claim 9, wherein the server computer application is configured for verifying that the NFC tag code is authentic and that the NFC code is assigned to a user.

15. A method for displaying at least one piece of information about an object on a mobile device, the method comprising the steps of:
providing a tag having a unique identifier;
affixing the tag to the object;
associating the unique identifier to the at least one piece of information on at least one web server;
reading the unique identifier with a mobile device;
retrieving the at least one piece of information from the at least one web server; and
displaying the at least one piece of information on the mobile device.

16. The method of claim 15, wherein the tag is a near field communication (‘NFC’) tag.

17. The method of claim 16, wherein the NFC tag is approximately 38 mm square.

18. The method of claim 16, wherein the unique identifier is an alphanumeric text string.

19. The method of claim 15, wherein the object includes at least one of a decoration, a picture, a notecard, a scrapbook and a container.

20. The method of claim 15, wherein the at least one piece of information is a web address, a picture, a video, an audio, an advertisement, and a flyer.
